(19) United States
(12) Patent Application Publication
(10) Pub. No.: US 2003/0210225 A1
(43) Pub. Date: Nov. 13, 2003

(54) Information processing apparatus

(76) Inventors: Hisaya Miyashita, Kanagawa (JP); Naohiko Otake, Chiba (JP); Ryo Yamamoto, Saitama (JP); Kenichi Agata, Tokyo (JP)

Correspondence Address: William S. Frommer, Esq., FROMMER LAWRENCE & HAUG LLP, 745 FIFTH AVENUE, NEW YORK, NY, 10151, US

(21) Appl. No.: 10/378,383

(22) Filed: Mar. 3, 2003

(30) Foreign Application Priority Data
Mar. 4, 2002 (JP) 2002-057651

(51) Int. Cl. G09G 5/00

(52) U.S. Cl. 345/156

(57) ABSTRACT

An information processing apparatus is disclosed which is superior in usability when it is used as a portable apparatus. The information processing apparatus includes an apparatus body section having a keyboard and a display section having a display screen and supported on the apparatus body section for pivotal motion by and around a pivot shaft. An indication mark moving operation member for moving an indication mark on the display screen is disposed at an end portion of the apparatus body section in an axial direction of the pivot shaft at an end portion of the apparatus body section adjacent the pivot shaft. A control operation member for controlling an object indicated by the indication mark moved on the display screen is disposed at the other end portion of the apparatus body in the axial direction of the pivot shaft at the end portion of the apparatus body section adjacent the pivot shaft.

### BACKGROUND OF THE INVENTION

This invention relates to an information processing apparatus, and more particularly to an information processing apparatus wherein a display section having a display screen is supported for pivotal motion on an apparatus body section having a keyboard.

An information processing apparatus such as, for example, a personal computer is available which includes an apparatus body section having a keyboard on which a plurality of operation keys are disposed and a display section having a display screen and supported for pivotal motion on the apparatus body section.

An information processing apparatus of the type described can execute various operations in response to an operation of a pointing device which includes an operation section called pointer which can be operated to turn in an arbitrary direction or an operation section called operation pad which can be operated by tracing on the surface thereof with a finger and another operation section called click button (a right button and a left button).

For example, the user can turn the pointer in an arbitrary direction to move an indication mark (mouse cursor) on the display screen to a desired icon and depress the click button to effect startup of software, display of a menu and so forth.

Such a pointing device as just described is in most cases disposed forward of the keyboard of the apparatus body section such that the pointer and two click buttons are disposed adjacent each other and in a forward and rearward juxtaposed relationship with each other. However, where the pointing device is positioned forward of the keyboard, a portion of the apparatus body section on the front side of the keyboard has an overall area increased as much by the pointing device, which makes an obstacle to miniaturization of the information processing apparatus. Further, where the pointing device is positioned forward of the keyboard, there is the possibility that, when the user operates the operation keys of the keyboard, it may touch with the pointing device erroneously, resulting in execution of an unintended operation of the information processing apparatus.

Therefore, in some information processing apparatus, the pointing device is disposed at a portion other than the display screen of the display section supported on the apparatus body section.

Incidentally, as popularization of information processing apparatus has proceeded in recent years, an information processing apparatus is demanded which not only can be used in a state wherein it is placed on a desk but also is superior in portability and can be used readily also in another state where it is held by a hand.

However, where the pointing device is disposed on the display section as in the conventional information processing apparatus described above, when it is used as a portable apparatus, the pointing device must be operated while the apparatus body section is held by one hand. Therefore, the conventional information processing apparatus has a drawback in that it is very poor in usability.

Further, also when such an information processing apparatus as described above is used in a state wherein it is placed on a desk, the pointing device must be operated, for example, with the thumb while the display section is held by one hand. Consequently, there is a drawback that the pointing device cannot be operated stably.

Also an information processing apparatus is available wherein the pointer of the pointing device is disposed at a position among predetermined operation keys of the keyboard, for example, among the alphabet keys of “G”, “B” and “H” in order to avoid such problems as described above. However, if the user tries to use the information processing apparatus just described as a portable apparatus in a state wherein it is held by both hands, then the thumb cannot extend to the pointing device, and after all, the user is obliged to operate the pointing device while holding the information processing apparatus with one hand. Further, since the pointing device is disposed among the keys of the keyboard, it is likely to be operated in error.

On the other hand, in operation of the pointing device, the pointer or the operation pad is operated very frequently while one of the click buttons is depressed. Thus, where an information processing apparatus is used as a portable apparatus, it should be configured such that a click button and the pointer can be operated at a time to improve the usability.

### SUMMARY OF THE INVENTION

It is an object of the present invention to provide an information processing apparatus that is superior in usability when it is used as a portable apparatus.

In order to attain the object described above, according to the present invention, there is provided an information processing apparatus, including a display section having a display screen on which an indication mark can be moved in response to a predetermined operation, an apparatus body section having a keyboard on which predetermined operation keys are provided, the display section being supported on the apparatus body section for pivotal motion by and around a pivot shaft in directions in which the display section opens and closes the keyboard, an indication mark moving operation member disposed at an end portion of the apparatus body section in an axial direction of the pivot shaft at an end portion of the apparatus body section adjacent the pivot shaft and operable for moving the indication mark, and a control operation member disposed at the other end portion of the apparatus body in the axial direction of the pivot shaft at the end portion of the apparatus body section adjacent the pivot shaft for controlling an object indicated by the indication mark moved on the display screen.

In the information processing apparatus, the indication mark moving operation member and the control operation member are present at positions at which the fingers of the user can touch with them when the user holds the information processing apparatus with both hands.

Accordingly, the user can operate the indication mark moving operation member and the control operation member while the apparatus body section is grasped with both hands thereof. Consequently, when the information processing apparatus is used as a portable apparatus, it becomes possible to improve the usability.

Further, since the indication mark moving operation member and the control operation member are disposed at the opposite end portions of the apparatus body section, the user can operate them simultaneously or successively with both hands.

The above and other objects, features and advantages of the present invention will become apparent from the following description and the appended claims, taken in conjunction with the accompanying drawings in which like parts or elements denoted by like reference symbols.

### BRIEF DESCRIPTION OF THE DRAWINGS

FIG. 1 is a perspective view showing an information processing apparatus to which the present invention is applied with a display section opened;

FIG. 2 is a plan view showing the information processing apparatus with the display section opened;

FIG. 3 is a side elevational view showing the information processing apparatus with the display section opened;

FIG. 4 is a rear elevational view showing the information processing apparatus with the display section opened;

FIG. 5 is a perspective view of the information processing apparatus showing the bottom face side with the display section closed;

FIG. 6 is an enlarged vertical sectional view of an indication mark moving operation section of the information processing apparatus;

FIG. 7 is a perspective view showing the information processing apparatus with a battery removed;

FIG. 8 is an enlarged perspective view showing arresting recesses formed on an apparatus body section of the information processing apparatus;

FIG. 9 is a perspective view showing a battery of a small size;

FIG. 10 is a perspective view showing arresting projections formed on a battery;

FIG. 11 is a schematic view illustrating a dimension between the arresting projections;

FIG. 12 is a perspective view showing a battery of a large size;

FIG. 13 is an enlarged perspective view of a locking mechanism used in the batteries of FIGS. 9 and 12;

FIG. 14 is an enlarged sectional view showing the locking mechanism and an unlocking lever;

FIG. 15 is an enlarged sectional view showing the locking mechanism where an arresting projection is inserted in an arresting recess;

FIG. 16 is an enlarged sectional view showing the locking mechanism where a battery is attached in a locked state to the apparatus body section;

FIG. 17 is an enlarged sectional view showing the locking mechanism where a battery is unlocked by an operation of the unlocking lever; and

FIG. 18 is an enlarged sectional view showing the locking mechanism where an arresting projection is released from an arresting recess.

### DESCRIPTION OF THE PREFERRED EMBODIMENT

An embodiment of the present invention is described below with reference to the drawings. In the embodiment described below, the present invention is applied to an information processing apparatus in the form of a personal computer which can be used also as a portable apparatus.

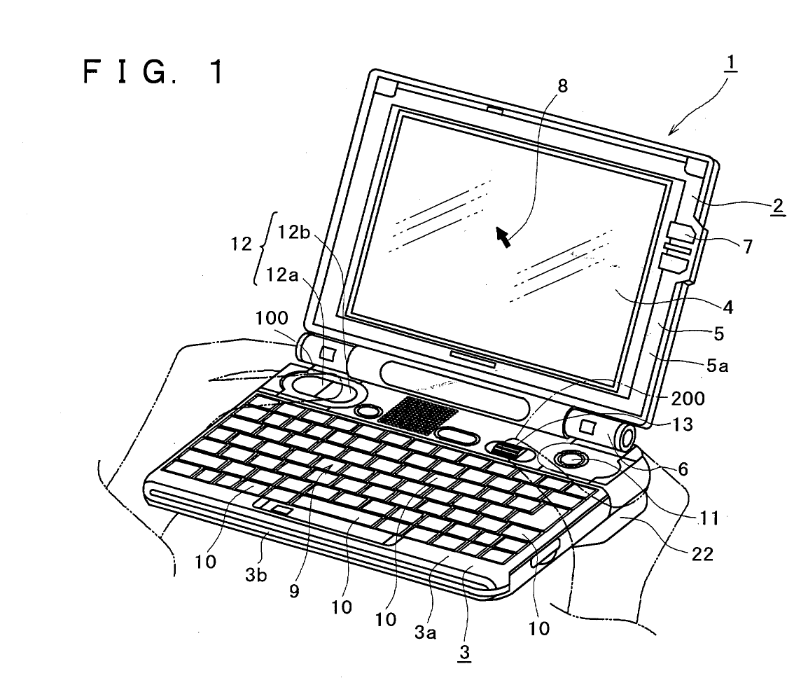

Referring first to FIGS. 1 to 5, the information processing apparatus 1 includes a display section 2 and an apparatus body section 3.

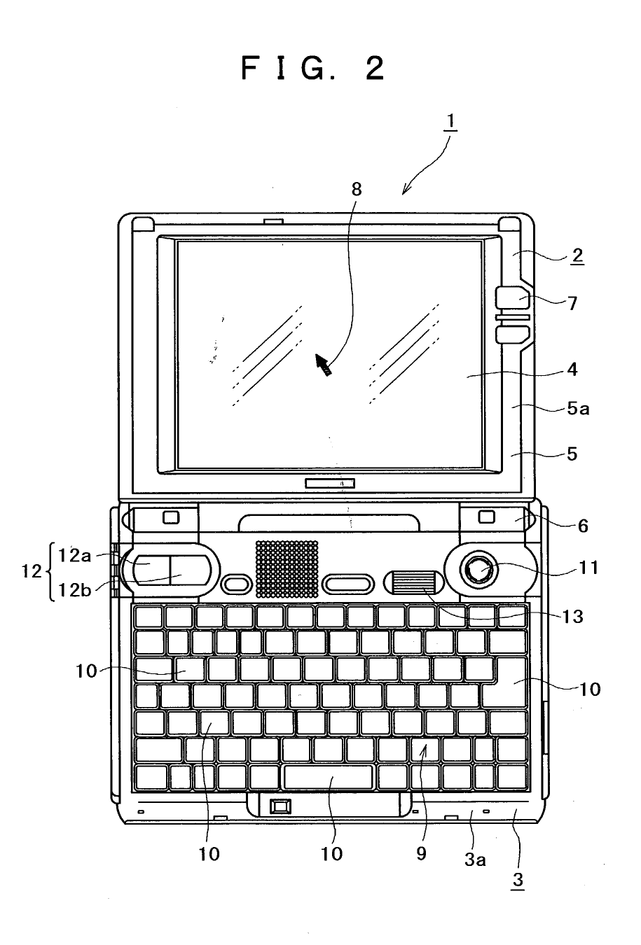

A display screen 4 having an LCD (Liquid Crystal Display) unit provided thereon is provided on the display section 2, and circumferential edges of the display screen 4 are formed as a frame section 5 as particularly seen in FIGS. 1 and 2.

The display section 2 is supported for pivotal motion around a pivot shaft or hinge shaft 6 extending in the leftward and rightward direction at a rear end portion of the apparatus body section 3 as seen in FIGS. 1 to 3.

A power supply button 7 is disposed at a right end portion of a front face 5a of the frame section 5. When the power supply button 7 is operated to make the power supply available, then icons, an indication mark or mouse cursor 8 and so forth are displayed on the display screen 4.

A keyboard 9 is provided on a top face portion 3a of the apparatus body section 3, and predetermined operation keys 10 are disposed on the keyboard 9 as seen in FIGS. 1 and 2. Though not shown in the drawings, processing means such as a CPU (Central Processing Unit) is provided in the inside of the apparatus body section 3 and performs various processes for signals inputted by operations of the operation keys 10 of the keyboard 9 and so forth.

An indication mark moving operation member 11 called pointer is disposed at a right end portion of a rear end portion of the top face portion 3a of the apparatus body section 3 such that the indication mark 8 is moved on the display screen 4 of the display section 2 in response to an operation of the indication mark moving operation member 11. The indication mark moving operation member 11 can be operated to turn in an arbitrary direction, and the indication mark 8 can be moved to a desired position on the display screen 4 by a turning operation of the indication mark moving operation member 11. It is to be noted that the indication mark moving operation member 11 may otherwise be an operation section called operation pad which can be operated by tracing on the surface with a finger.

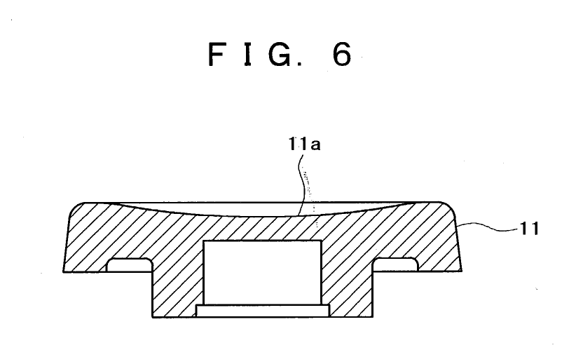

A concave portion 11a for operation is formed on the top face of the indication mark moving operation member 11 as particularly seen in FIG. 6. Referring to FIG. 6, the face that defines the concave portion 11a is formed, for example, in a substantially moderate spherical face. Accordingly, the user can touch with the concave portion 11a using a finger thereof to operate the indication mark moving operation member 11. Consequently, a good operation feeling can be obtained and good operability can be achieved. For example, if the user touches with the concave portion 11a using a finger thereof to operate the indication mark moving operation member 11 slowly, then the indication mark 8 is moved slowly on the display screen 4, but if the user touches with the concave portion 11a using a finger to operate the indication mark moving operation member 11 in a strongly pushing manner, then the indication mark 8 is moved on the display screen 4 swiftly.

It is to be noted that, where the indication mark moving operation member 11 otherwise is an operation pad which can be operated by tracing on the surface thereof with a finger, there is no necessity to form a concave portion on the operation pad.

A control operation section 12 corresponding to the left button and the right button of the mouse is disposed at a left end portion of the rear end portion of the top face portion 3a of the apparatus body section 3. The control operation section 12 includes a first operation member 12a called left click button and a second operation member 12b called right click button. The control operation section 12 exhibits a predetermined function by a pushing operation thereof. In particular, if the first operation member 12a is operated, then, for example, software of an icon indicated by the indication mark 8 is started up, but if the second operation member 12b is operated, then, for example, a menu having a plurality of items relating to the icon indicated by the indication mark 8 is displayed on the display screen 4.

A turning and pressing operation member 13 called jog dial is disposed in the proximity of the indication mark moving operation member 11 on the top face portion 3a of the apparatus body section 3, for example, at a position immediately on the left side of the indication mark moving operation member 11. If the turning and pressing operation member 13 is operated to turn, then, for example, one of items of a menu displayed on the display screen 4 in response to an operation of the second operation member 12b can be selected arbitrarily, and then if the turning and pressing operation member 13 is operated to be pushed, then, for example, the selected item of the menu can be executed.

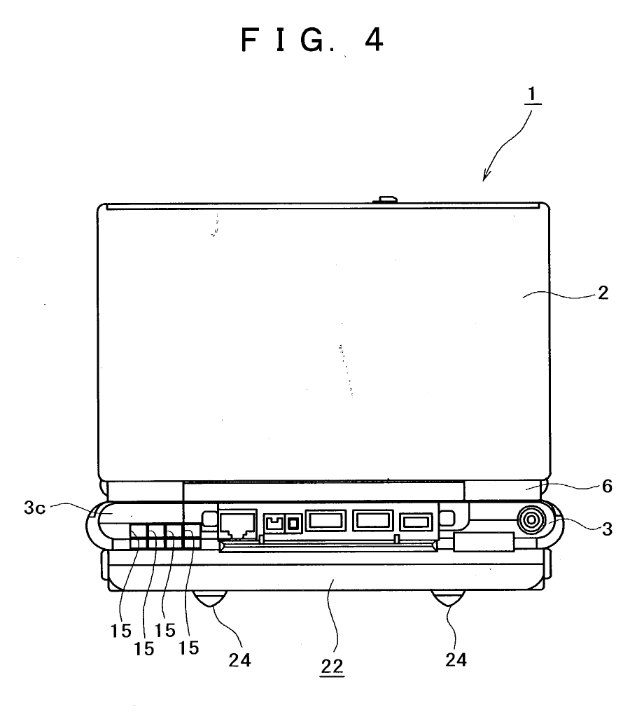

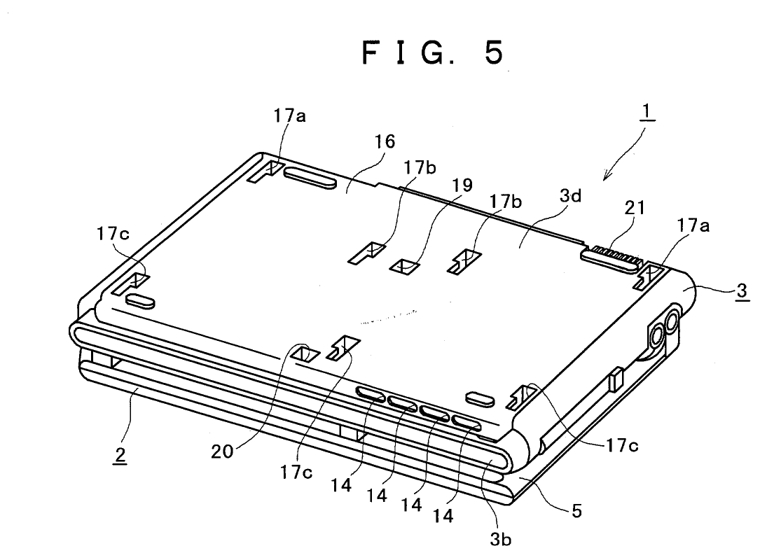

A plurality of inlet ports 14 are formed in a leftward and rightward juxtaposed relationship in a front face portion 3b of the apparatus body section 3 as particularly seen in FIG. 5. Meanwhile, a plurality of outlet ports 15 are formed in a leftward and rightward juxtaposed relationship in a rear face portion 3c of the apparatus body section 3 as particularly seen in FIG. 4.

Accordingly, when the information processing apparatus 1 is used, external air is taken into the inside of the apparatus body section 3 through the inlet ports 14 to cool the inside of the apparatus body section 3, the external air used for the cooling is exhausted to outside the information processing apparatus 1 through the outlet ports 15.

The information processing apparatus 1 is used also as a portable apparatus. When it is used as a portable apparatus, the user will grip the opposite left and right side edge portions of the apparatus body section 3 with both hands thereof and operate the apparatus body section 3 as seen in FIG. 1.

Accordingly, since the outlet ports 15 are formed in the rear face portion 3c of the apparatus body section 3, when the information processing apparatus 1 is used as a portable apparatus, external air is not exhausted toward the hands or the fingers of the operator, and therefore, good operability of the information processing apparatus 1 can be secured. Further, since the inlet ports 14 and the outlet ports 15 are formed in the front face portion 3b and the rear face portion 3c of the apparatus body section 3, respectively, when the information processing apparatus 1 is used as a portable apparatus, the inlet ports 14 or the outlet ports 15 are not covered with a hand of the user, and consequently, an appropriate cooling function can be secured. Furthermore, since the outlet ports 15 are not formed in the front face portion 3b of the apparatus body section 3, external air is not exhausted toward the user, and consequently, further good operability of the information processing apparatus 1 can be secured.

When the information processing apparatus 1 is used as a portable apparatus, the operator will hold the left and right end portions of the apparatus body section 3 with both hands thereof and operate the information processing apparatus 1 as seen in FIG. 1. In the information processing apparatus 1, the indication mark moving operation member 11 is disposed at the right end portion of the rear end portion of the top face portion 3a of the apparatus body section 3 while the control operation section 12 is disposed at the left end portion of the rear end portion of the top face portion 3a of the apparatus body section 3.

Accordingly, while the user holds the apparatus body section 3 with both hands thereof, it can operate the indication mark moving operation member 11 and the control operation section 12, for example, with the right and left thumbs 200 and 100, respectively, as seen in FIG. 1. Since the indication mark moving operation member 11 and the control operation section 12 can be operated while the apparatus body section 3 is held with both hands of the user in this manner, the usability of the information processing apparatus 1 when it is used as a portable apparatus can be improved.

Further, since the indication mark moving operation member 11 and the control operation section 12 are disposed at the opposite right and left end portions of the top face portion 3a of the apparatus body section 3, they can be operated at a time or successively.

Furthermore, since the indication mark moving operation member 11 and the control operation section 12 are disposed at positions spaced away from the keyboard 9, such a situation that the operation keys 10 of the keyboard 9 are operated in error can be prevented, and consequently, operation in error of the information processing apparatus 1 can be prevented.

In addition, since the control operation section 12 is formed from the first operation member 12a and the second operation member 12b, various operations can be performed and usability can be anticipated.

In the information processing apparatus 1, the turning and pressing operation member 13 is disposed at a position of the top face portion 3a of the apparatus body section 3 in the proximity of the indication mark moving operation member 11. Accordingly, even where the information processing apparatus 1 is used as a portable apparatus as described above, the turning and pressing operation member 13 can be used while the apparatus body section 3 is held by both hands of the user, and consequently, improvement in usability can be anticipated.

Particularly since the turning and pressing operation member 13 which is used frequently together with operation of the control operation section 12 is disposed at an end portion opposite to the side at which the control operation section 12 is disposed, the control operation section 12 and the turning and pressing operation member 13 can be operated with fingers of the different hands, and consequently, good operability is secured.

It is to be noted that the turning and pressing operation member 13 may otherwise be disposed in the proximity of the control operation section 12, for example, at a position immediately on the right side with respect to the control operation section 12.

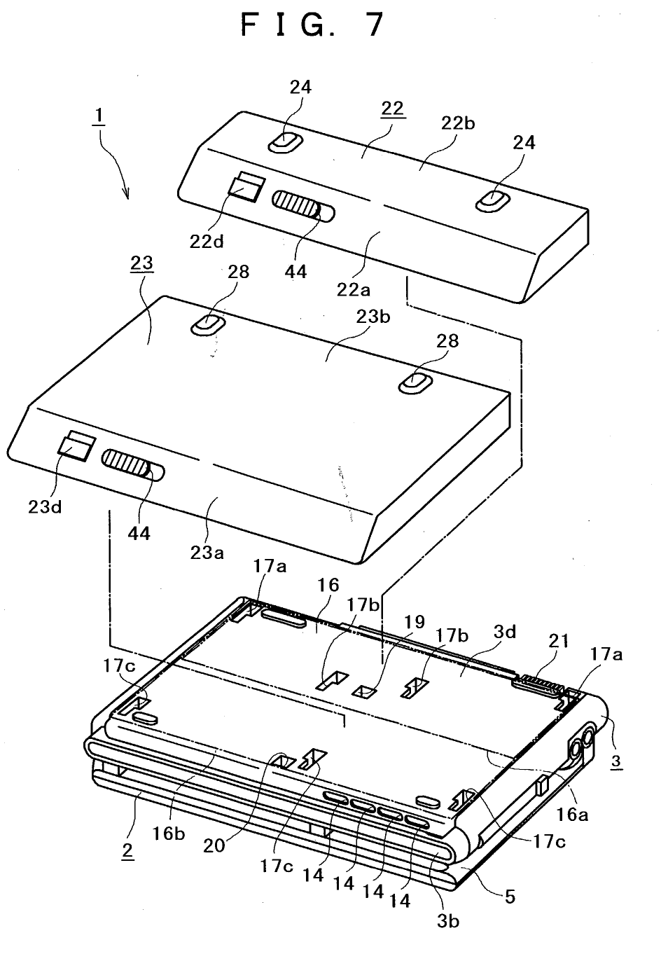

A lower face portion 3d of the apparatus body section 3 is formed as a battery attachment portion 16 as seen in FIGS. 5 and 7. Referring to FIG. 7, the battery attachment portion 16 includes a first region 16a to which a battery of a small size hereinafter described is to be attached, and a second region 16b to which a battery of a large size is to be attached. The first region 16a is defined by a rear half portion of the lower face portion 3d while the second region 16b is defined by a substantially overall face of the lower face portion 3d.

Totaling seven arresting recesses 17a, 17a, 17b, 17b, 17c, 17c and 17c are formed on the battery attachment portion 16.

The arresting recesses 17a are formed at the left and right end portions of a rear end portion of the battery attachment portion 16. The arresting recesses 17b are formed in a leftward and rightward spaced relationship from each other at positions of a substantially central portion of the battery attachment portion 16 in the leftward and rightward direction on the rather rear side than the center portion in the forward and backward direction. The arresting recesses 17c are formed at the opposite left and right end portions and a substantially central portion in the leftward and rightward direction at a front end portion of the battery attachment portion 16.

The arresting recesses 17a and the arresting recesses 17b are used when a battery of the small size is attached, and the arresting recesses 17a and the arresting recesses 17c are used when a battery of the large size is attached. Accordingly, the arresting recesses 17a are used commonly for attachment of a battery of the small size and a battery of the large size.

Since the arresting recesses 17a for common use are formed in this manner, the production cost of the apparatus body section 3 can be reduced.

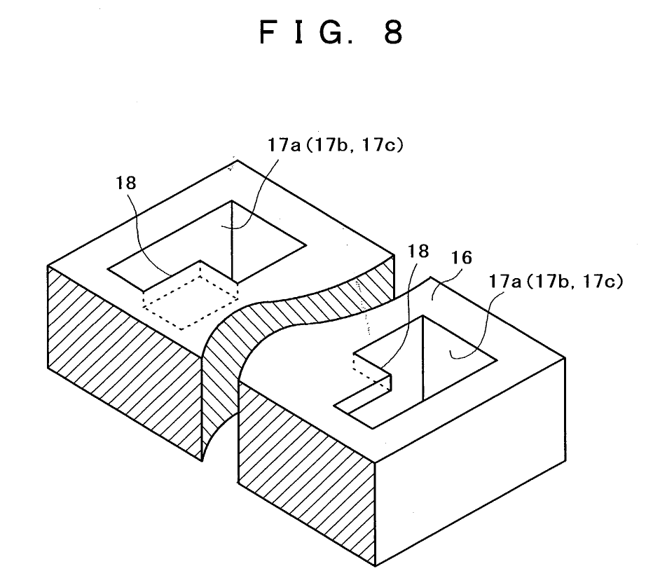

At each of portions of the battery attachment portion 16 at which the arresting recesses 17a, 17b and 17c are formed, an arresting portion 18 is formed such that it projects sidewardly in such a manner that it covers a portion of the opening of the arresting recess 17a, 17b or 17c as particularly seen in FIG. 8.

Referring to FIGS. 5 and 7, a locking hole 19 is formed on the battery attachment portion 16 between the arresting recesses 17b and 17b, and another locking hole 20 is formed in the proximity of that one of the arresting recesses 17c which is positioned centrally in the leftward and rightward direction.

A connector coupling portion 21 having a plurality of connection terminals is provided on the apparatus body section 3. The connector coupling portion 21 is positioned at a left end portion of the rear end portion of the apparatus body section 3 and extends from the rear face portion 3c to the lower face portion 3d.

The locking hole 19 positioned on the rear side is used when a battery of the small size is attached, and the locking hole 20 positioned on the front side is used when a battery of the large size is attached.

Referring to FIG. 7, a battery 22 of the small size or a battery 23 of the large size is attached to the battery attachment portion 16 of the apparatus body section 3.

The battery 22 of the small size has such a flattened configuration that the dimension in the leftward and rightward direction in FIG. 7 is considerably greater than the dimension in the depthwise direction in FIG. 7, and has an inclined portion inclined portion 22a positioned on the front side thereof.

A pair of support pads 24 are provided in a leftward and rightward spaced relationship from each other at a lower wall portion 22b of the battery 22 of the small size which is contiguous to one end portion of the inclined portion inclined portion 22a. The support pads 24 are formed, for example, from a rubber material.

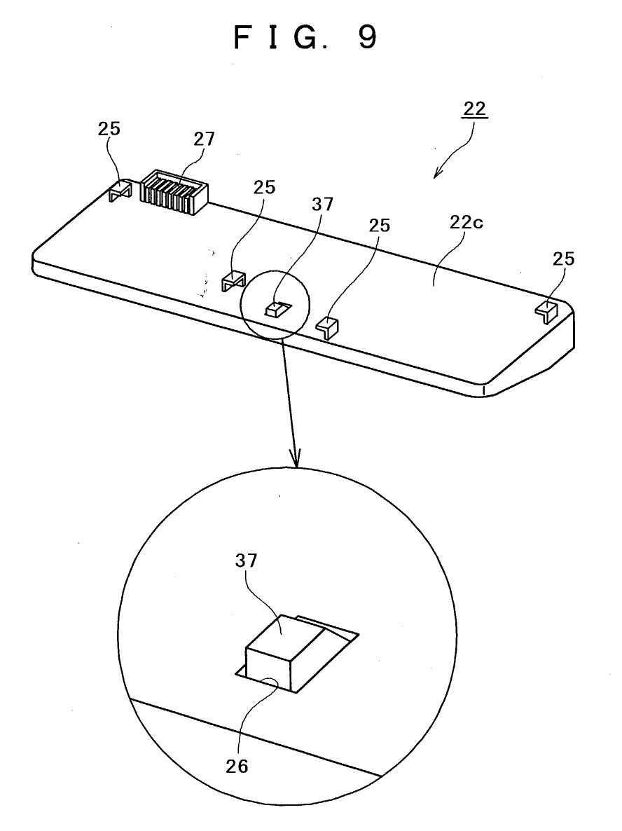

Four arresting projections 25 are provided in an upwardly projecting manner on an upper wall portion 22c of the battery 22 which is contiguous to the other end edge of the inclined portion inclined portion 22a as particularly seen in FIG. 9.

Referring to FIG. 9, the arresting projections 25 are provided in a leftward and rightward spaced relationship from each other at the opposite left and right end portions of the rear end portion of the upper wall portion 22c and at substantially central portions of the upper wall portion 22c in the leftward and rightward direction.

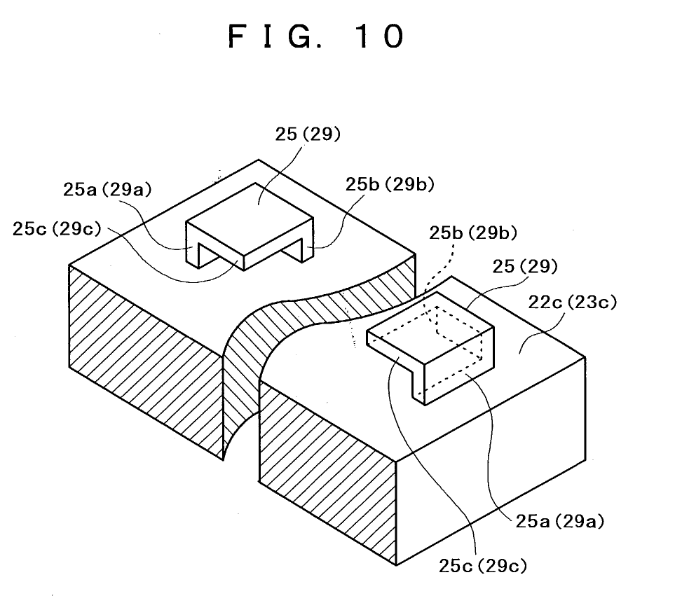

Referring to FIG. 10, each of the arresting projections 25 includes a pair of base portions 25a and 25b extending upwardly from the upper wall portion 22c, and an arresting piece portion 25c provided in such a manner as to connect the base portions 25a and 25b to each other. The base portions 25a and 25b extend perpendicularly to each other. The arresting projection 25 is provided such that it connects upper edges of the base portions 25a and 25b to each other and extends in parallel to the upper wall portion 22c of the battery 22.

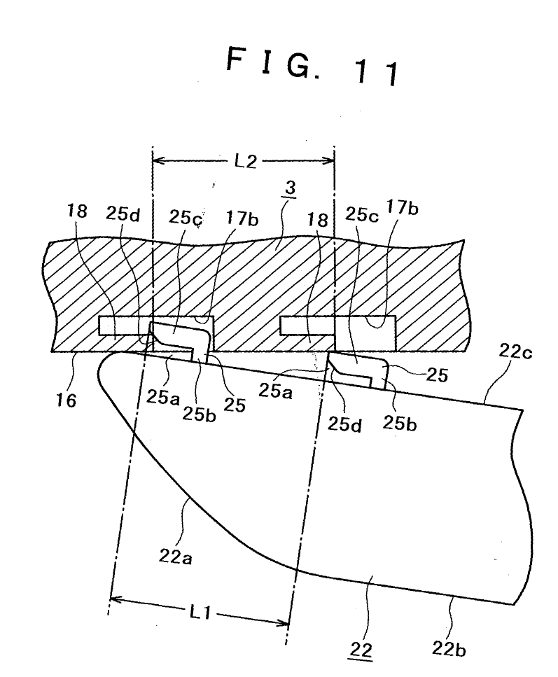

A front end of the arresting piece portion 25c of the arresting projection 25 is inclined such that it is displaced rearward to the downward direction and serves as a guide edge 25d as particularly seen in FIGS. 10 and 11.

Referring to FIG. 9, an insertion hole 26 is formed in the upper wall portion 22c of the battery 22 between the arresting projections 25 positioned on the front side.

Those two of the arresting projections 25 which are positioned on the front side are positioned in a displaced relationship from each other in the forward and backward direction.

On the other hand, from among the arresting recesses 17a, 17b and 17c formed at positions corresponding to the arresting projections 25, for example, also the arresting recesses 17b which correspond to the two arresting projections 25 which are disposed on the front side of the battery 22 are formed in a spaced relationship from each other in the forward and backward direction in a corresponding relationship to the two arresting projections 25 described above.

Referring to FIG. 11, the distance L1 between corresponding portions of the two arresting projections 25 in the forward and backward direction is set substantially equal to the distance L2 between corresponding portions of the arresting portions 18 provided corresponding to the arresting recesses 17b in the forward and backward direction.

It is to be noted that, in the information processing apparatus 1, the relationship that the distance L1 and the distance L2 are substantially equal to each other applies not only to the two arresting projections 25 and the arresting portions 18 but also to all of the arresting projections 25 at the positions in the forward and backward direction of the battery 22 and all of the corresponding arresting portions 18 of the apparatus body section 3. Further, this similarly applies also to all of the engaging projections provided at positions in the forward and backward direction on a battery of the large size hereinafter described and all of the corresponding arresting portions 18 of the apparatus body section 3.

A connector portion 27 having a plurality of connection terminals is provided at a left end portion of the rear end portion of the upper wall portion 22c of the battery 22.

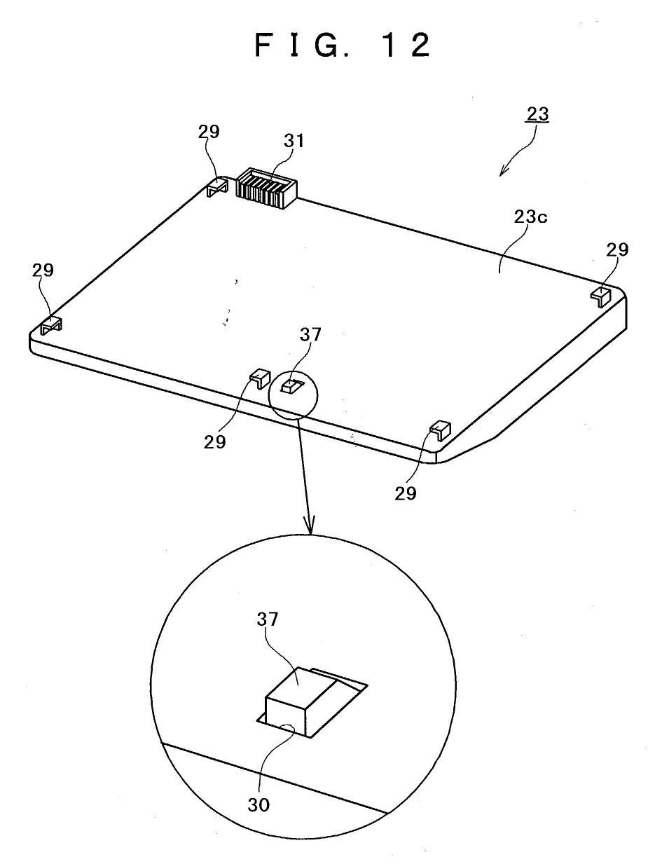

Referring now to FIGS. 7 and 12, the battery 23 of the large size is formed in such a flattened shape that the dimension thereof in the leftward and rightward direction is substantially equal to the dimension of the battery 22 of the small size in the leftward and rightward direction and the dimension in the depthwise direction is considerably greater than that of the battery 22 of the small size. The battery 23 of the large size has an inclined portion 23a positioned on the front side thereof.

A pair of support pads 28 are provided in a leftward and rightward spaced relationship from each other at positions rather near to a rear end of a lower wall portion 23b of the battery 23 which is contiguous to one end edge of the inclined portion 23a. The support pads 28 are formed from, for example, a rubber material.

Five arresting projections 29 are provided in an upwardly projecting manner on an upper wall portion 23c of the battery 23 that is contiguous to the other end edge of the inclined portion 23a as particularly seen in FIG. 12.

The arresting projections 29 are provided at the opposite left and right end portions of a rear end portion of the upper wall portion 23c, the opposite left and right end portions of a front end portion of the upper wall portion 23c, and a substantially central portion of the front end portion of the upper wall portion 23c in the leftward and rightward direction.

The arresting projections 29 are formed in a shape similar to that of the arresting projections 25 provided on the battery 22, and each of the arresting projections 29 includes a pair of base portions 29a and 29b extending upwardly from the upper wall portion 22c and an arresting piece portion 29c provided in such a manner as to connect the base portions 29a and 29b to each other.

The front edge of the arresting piece portion 29c of each of the arresting projections 29 is inclined such that it is displaced downwardly rearwards and is formed as a guide edge 29d.

An insertion hole 30 is formed at a portion of the upper wall portion 23c of the battery 23 in the proximity of that one of the arresting projections 29 which is positioned centrally on the front side.

A connector portion 31 having a plurality of connection terminals is provided at a left end portion of the rear end portion of the upper wall portion 23c of the battery 23.

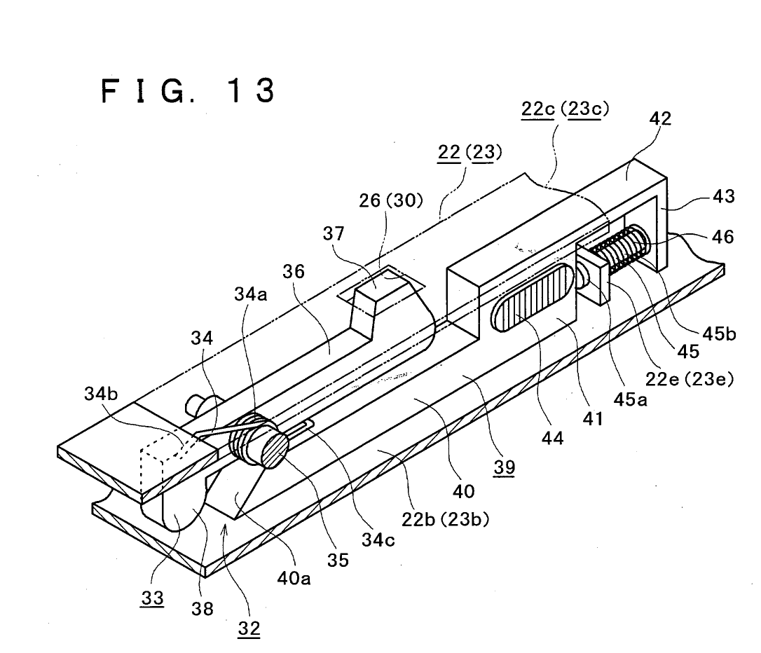

Referring to FIG. 13, a locking mechanism 32 is disposed in the inside of each of the battery 22 and the battery 23.

The locking mechanism 32 includes a locking lever 33, a biasing spring 34, and a support shaft 35.

The locking lever 33 is formed as a unitary member including a main portion 36 elongated in the leftward and rightward direction, a locking projection 37 projecting upwardly from a right end portion of the main portion 36, and a pressed projection 38 projecting substantially downwardly from a left end portion of the main portion 36.

The locking lever 33 is supported at the main portion 36 thereof for pivotal motion around the support shaft 35. The support shaft 35 is secured at the opposite end portions thereof to mounting portions not shown. The support shaft 35 is disposed such that the axial direction thereof is the forward and backward direction and expends perpendicularly to the longitudinal direction of the main portion 36. Accordingly, the locking lever 33 is pivoted such that the locking projection 37 and the pressed projection 38 are moved substantially in the upward and downward directions.

The biasing spring 34 is supported on the support shaft 35. The biasing spring 34 is in the form of a torsion coil spring and includes a coiled portion 34a and a pair of resiliently contacting portions 34b and 34c extending in different directions from each other from the coiled portion 34a. The biasing spring 34 is supported at the coiled portion 34a thereof on the support shaft 35 such that the resiliently contacting portion 34b resiliently contacts from below with the upper wall portion 22c of the locking lever 33 or the upper wall portion 23c of the battery 23 of the large size while the other resiliently contacting portion 34c resiliently contacts from below with the lower face of the main portion 36. Accordingly, the locking lever 33 is biased by the biasing spring 34 in the direction in which the locking projection 37 moves substantially upwardly.

The locking lever 33 is positioned such that the locking projection 37 thereof is aligned with the insertion hole 26 of the battery 22 or the insertion hole 30 of the battery 23, and in a state wherein no external force is applied to the locking lever 33, the locking projection 37 projects upwardly from the insertion hole 26 or the insertion hole 30 under the biasing force of the biasing spring 34 as seen in FIGS. 9, 12 and 14.

An unlocking lever 39 is supported for sliding movement in the leftward and rightward directions in the neighborhood of the locking lever 33. The unlocking lever 39 is movable in the leftward and rightward directions under the guidance of a guide portion not shown provided on the lower wall portion 22b of the battery 22 or the lower wall portion 23b of the battery 23.

The unlocking lever 39 has a supported portion 40 elongated in the leftward and rightward direction, a knob receiving portion 41 projecting upwardly from a right end portion of the supported portion 40, a connecting portion 42 projecting rightwardly from an upper end portion of the knob receiving portion 41, and an outer wall portion 43 projecting downwardly from a right end portion of the connecting portion 42.

An operating face 40a is formed at a left end portion of the supported portion 40 such that it is inclined in such a manner that it is displaced leftwardly downwards.

An operation knob 44 is provided on one side face of the knob receiving portion 41. The operation knob 44 projects outwardly through an arrangement hole not shown formed in the inclined portion 22a of the battery 22 or an arrangement hole not shown formed in the inclined portion 23a of the battery 23 such that it can be operated in the leftward and rightward directions in FIG. 7.

Hold knobs 22d and 23d are provided on the inclined portion inclined portion 22a of the battery 22 and the inclined portion 23a of the battery 23, respectively, as seen in FIG. 7. If the knob 22d or 23d is operated to slidably move in one of the leftward and rightward directions, then the unlocking lever 39 is held against sliding movement, but if the knob 22d or 23d is operated to slidably move in the opposite direction, then the unlocking lever 39 can be moved slidably.

A spring supporting shaft 45 is provided on the outer wall portion 43 such that it projects leftward. The spring supporting shaft 45 has an end portion formed thicker than the other portion thereof, and the end portion is formed as a restricting portion 45a while the other end portion is formed as a spring supporting portion 45b.

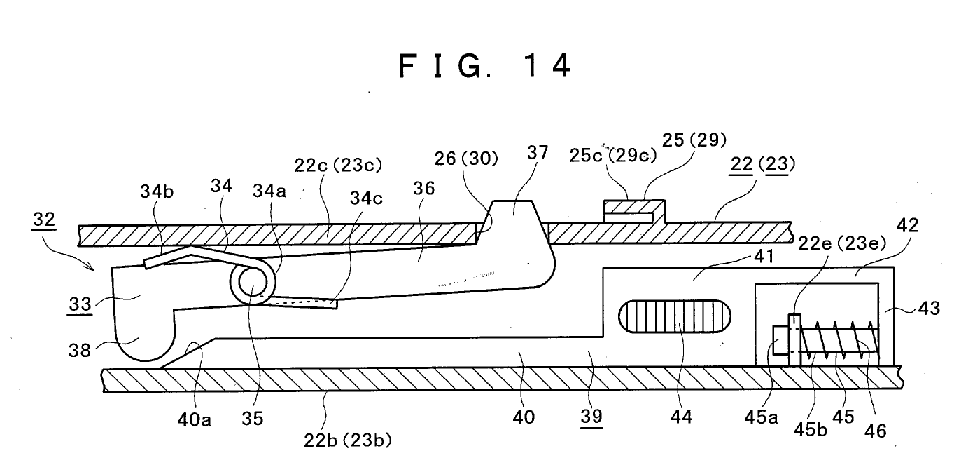

Referring to FIG. 14, a supporting wall portion 22e and a supporting wall portion 23e extending upwardly are provided on an inner face of the lower wall portion 22b of the battery 22 and an inner face of the lower wall portion 23b of the battery 23, respectively.

The spring supporting shaft 45 of the unlocking lever 39 is inserted from rightward in and supported by the supporting wall portion 22e or 23e, and letting off of the spring supporting portion 45b from the supporting wall portion 22e or ²3e is prevented by the restricting portion 45a. A compression coil spring 46 is supported on the spring supporting shaft 45 in a state wherein the spring supporting portion 45b of the spring supporting shaft 45 is supported by the supporting wall portion 22e or 23e. Accordingly, rightward biasing force is applied from the compression coil spring 46 to the unlocking lever 39.

In a state before the operation knob 44 is operated, the unlocking lever 39 is positioned at a rightward limit position within a range of movement under the rightward biasing force of the compression coil spring 46, that is, at a non-unlocking position at which it does not perform an unlocking movement. In this position of the unlocking lever 39, the operating face 40a thereof is positioned rightwardly of the pressed projection 38 of the locking lever 33 as seen in FIG. 14. Accordingly, when the unlocking lever 39 is in the non-unlocking position, if the locking lever 33 is pivoted within the range of pivotal motion thereof, then the pressed projection 38 does not contact with the unlocking lever 39. In other words, when the unlocking lever 39 is in the non-unlocking position, the unlocking lever 39 is not positioned on the locus of the pivotal motion of the locking lever 33.

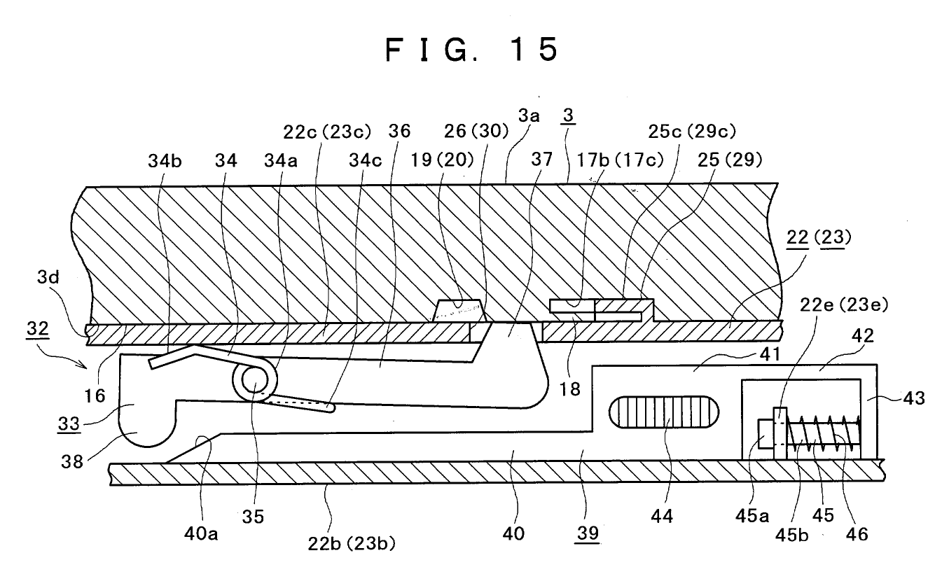

In the following, movements of the associated elements when the battery 22 is attached to and detached from the apparatus body section 3 is described with reference to FIGS. 15 to 18. It is to be noted that, while, in FIGS. 15 to 18, the relationship between the orientation in which the locking mechanism 32 is disposed and the orientation of the apparatus body section 3 is different from the actual relationship of them, in order to facilitate description, it is assumed that the longitudinal direction of the locking lever 33 is the forward and backward direction.

The battery 22 is attached to the first region 16a of the battery attachment portion 16 of the apparatus body section 3.

First, the arresting projections 25 provided on the upper wall portion 22c of the battery 22 are inserted from below into the arresting recesses 17a and 17b formed on the lower face portion 3d of the apparatus body section 3 as seen in FIG. 15. In this instance, the insertion hole 26 of the battery 22 is positioned in a displaced relationship a little rearward from the locking hole 19 of the apparatus body section 3. Accordingly, the locking projection 37 projecting upwardly from the insertion hole 26 is pressed downwardly by the lower face portion 3d of the apparatus body section 3 thereby to pivot the locking lever 33 against the biasing force of the biasing spring 34 until the locking projection 37 is positioned into the inside of the battery 22 as seen in FIG. 15.

When it is tried to insert the arresting projections 25 from below into the arresting recesses 17a and 17b as described above, the battery 22 is sometimes placed into an inappropriate state such as, for example, a state wherein it is inclined with respect to the apparatus body section 3. At this time, for example, only one of the arresting projections 25 may be inserted into an arresting recess 17b as seen in FIG. 11. In this instance, however, since the distance L1 between the arresting projections 25 is substantially equal to the distance L2 between the arresting portions 18 as described hereinabove, even if it is tried to slidably move the battery 22 forwardly, the arresting projection 25 on the trailing side interferes with the arresting portion 18 to block the battery 22 from slidably forward moving. Accordingly, the user can discriminate that the arresting projections 25 are not inserted correctly.

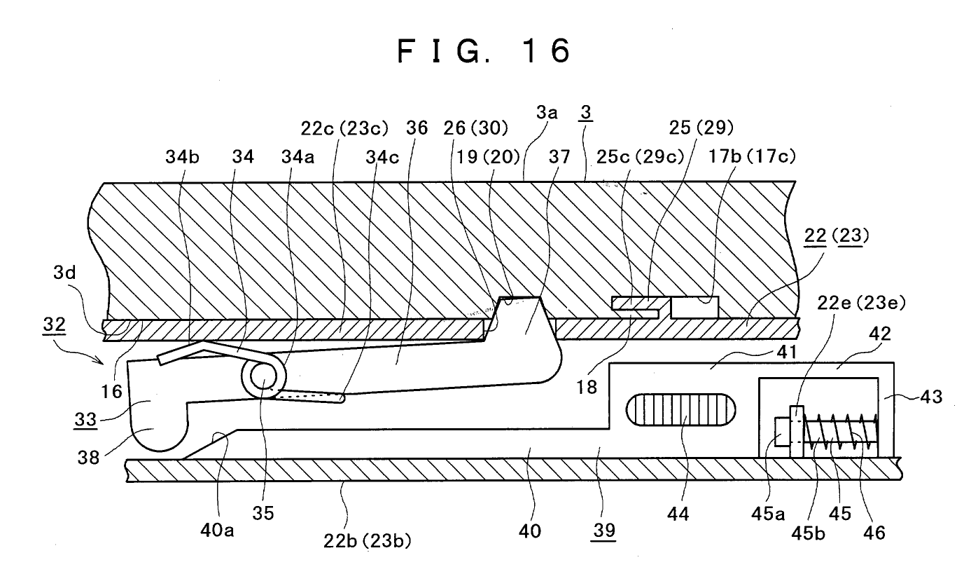

Then, the battery 22 is slidably moved forward with respect to the apparatus body section 3 as seen in FIG. 16. At this time, the guide edges 29d of the arresting projections 25c of the arresting projections 25 are slidably engaged with the rear edges of the arresting portions 18 and the arresting projections 25c are inserted on the upper side of the arresting portions 18 of the apparatus body section 3.

When the arresting projections 25c are inserted on the upper side of the arresting portions 18, they are latched in a face-to-face contacting relation by the arresting portions 18. At this time, the insertion hole 26 of the battery 22 of the small size is positioned just below the locking hole 19 of the apparatus body section 3. Accordingly, the locking lever 33 is pivoted by the biasing force of the biasing spring 34 to project the locking projection 37 thereof upwardly from the insertion hole 26 again until it is inserted into and fitted with the locking hole 19 as seen in FIG. 16. As the locking projection 37 is inserted in and fitted with the locking hole 19, the battery 22 is attached in a locked state to the apparatus body section 3.

The battery 22 is attached in a locked state to the apparatus body section 3 in such a manner as described above. Accordingly, since the attachment of the battery 22 in a locked state to the apparatus body section 3 is performed only through engagement of the arresting projections 25c with the arresting portions 18 and insertion and fitting of the locking projection 37 of the locking lever 33 biased by the biasing spring 34 into and with the locking hole 19, the mechanism for such attachment and locking can be simplified, and besides, such attachment and locking of the battery 22 of the small size to the apparatus body section 3 can be performed readily by simple movement.

Further, although the locking lever 33 is pivoted when the locking projection 37 thereof is inserted into the locking hole 19, the locking lever 33 does not contact with the unlocking lever 39 as described hereinabove.

Accordingly, the locking lever 33 can be pivoted with certainty to insert the locking projection 37 thereof into the locking hole 19 without being acted upon by unnecessary external force from the unlocking lever 39.

Further, upon locking operation of the locking lever 33, the unlocking lever 39 does not slidably move, and consequently, such an unnecessary operation as sliding movement of the operation knob 44 does not occur, and the appearance is good.

When the battery 22 is slidably moved until it is attached to the apparatus body section 3, simultaneously the connector portion 27 of the battery 22 of the small size is coupled to the connector coupling portion 21 provided on the apparatus body section 3.

Accordingly, only if the battery 22 is slidably moved forward with respect to the apparatus body section 3, then the battery 22 is locked and mechanically coupled to the apparatus body section 3 and the connector portion 27 is coupled to the connector coupling portion 21 to establish an electric connection between the apparatus body section 3 and the battery 22. Consequently, the mechanical coupling and the electrical coupling need not be performed by separate movements, and improvement of the operability in attaching operation of the battery 22 of the small size to the apparatus body section 3 can be anticipated.

If the operation knob 44 is operated in a state wherein the battery 22 is locked to the apparatus body section 3, then the locking of the battery 22 of the small size is canceled in the following manner.

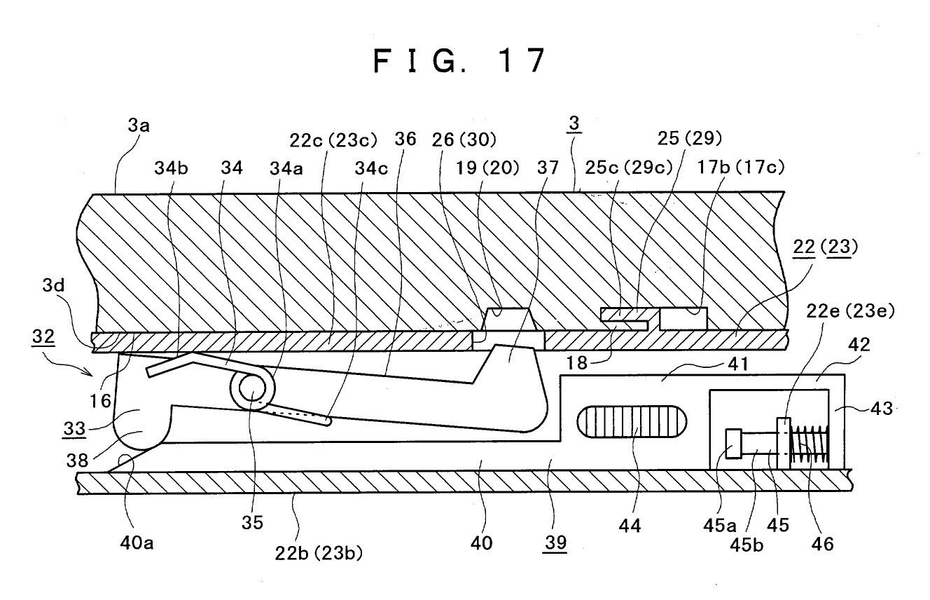

If the operation knob 44 is slidably operated, then the unlocking lever 39 is moved toward the pressed projection 38 of the locking lever 33, whereupon the pressed projection 38 of the locking lever 33 is pressed leftwardly by the operating face 40a as seen in FIG. 17. When the pressed projection 38 is pressed by the operating face 40a, the locking lever 33 is pivoted in a direction in which the locking projection 37 thereof moves downwardly against the biasing force of the biasing spring 34 thereby to cancel the locked state of the battery 22 of the small size to the apparatus body section 3.

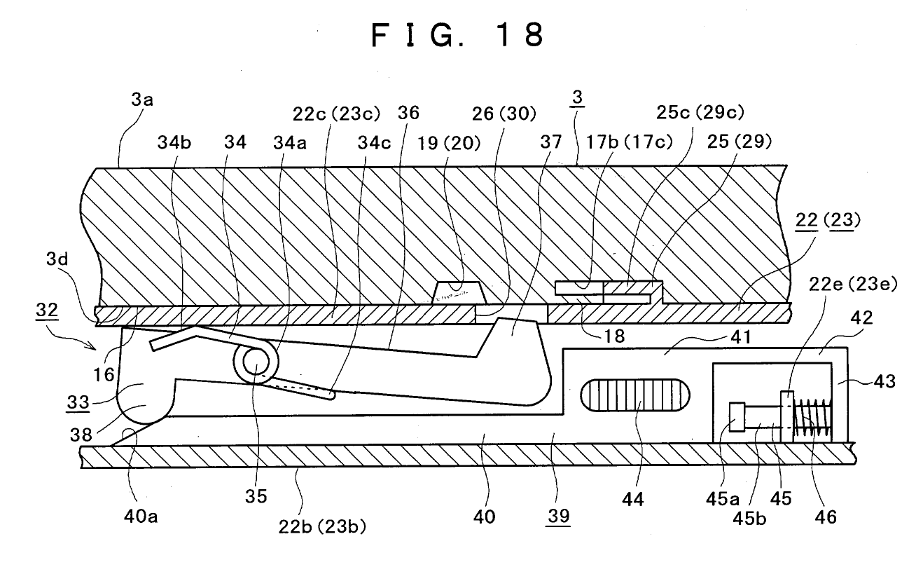

If the battery 22 is slidably moved rearward with respect to the apparatus body section 3 in the state wherein the locked state of the battery 22 is canceled, then the engagement between the arresting projections 25c of the arresting projections 25 of the battery 22 and the arresting portions 18 of the apparatus body section 3 is canceled as seen in FIG. 18. When the engagement between the arresting projections 25c and the arresting portions 18 is canceled, the battery 22 can be removed from the apparatus body section 3 by moving the apparatus body section 3 and the battery 22 away from each other in the vertical directions.

As described above, the locking lever 33 effects locking or unlocking when the locking projection 37 thereof is moved in a substantially vertical direction, that is, moved toward or away from the apparatus body section 3. Accordingly, even if external force in a forward or backward direction in which the battery 22 and the apparatus body section 3 are moved away from each other is applied to the battery 22 or the apparatus body section 3, since the direction for such removal and the direction of the movement of the locking projection 37 are substantially perpendicular to each other, the locked state of the battery 22 to the apparatus body section 3 is not canceled readily at all.

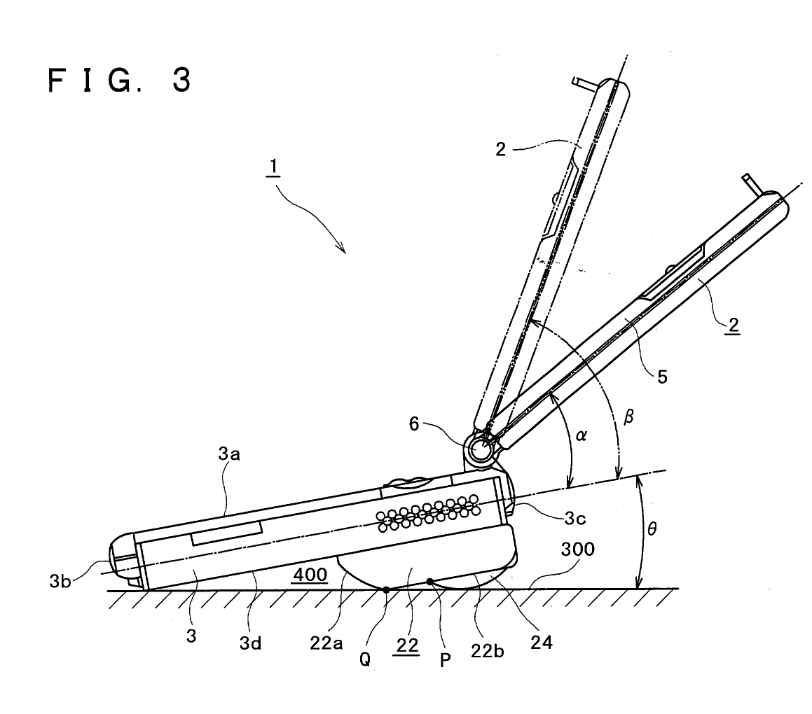

When the information processing apparatus 1 is to be used as an apparatus of the installed type in the state wherein the battery 22 is attached to the apparatus body section 3, the information processing apparatus 1 is placed on a desk 300 or the like such that the battery 22 and a front end portion of the apparatus body section 3 contact with the desk 300 or the like as seen in FIG. 3. In this state, the support pads 24 provided on the lower wall portion 22b of the battery 22 contact with the desk 300 or the like.

Accordingly, since the support pads 24 are provided on the battery 22, when the information processing apparatus 1 is used as an apparatus of the installed type, it can be supported in a stabilized state.

On the other hand, when the information processing apparatus 1 is placed on the desk 300 or the like in a state wherein the battery 22 is attached thereto in order the user to use the same, since the apparatus body section 3 is inclined by a predetermined angle θ with respect to the desk 300 or the like as seen in FIG. 3, the operation keys 10, indication mark moving operation member 11, control operation section 12, turning and pressing operation member 13 and so forth provided on the apparatus body section 3 can be operated readily. Consequently, improvement in operability is anticipated.

Furthermore, since the battery 22 contacts with the desk 300 or the like, a gap 400 is formed between the apparatus body section 3 and the desk 300 or the like, and consequently, the user can insert its hands or fingers readily into the gap 400 to lift the information processing apparatus 1, which facilitates transportation of the information processing apparatus 1.

When the information processing apparatus 1 is used, the display section 2 is opened with an arbitrary angle with respect to the apparatus body section 3 as seen in FIG. 3. When the information processing apparatus 1 is in this state, the center of gravity of the information processing apparatus 1 is positioned at a lower end of the battery 22 as described below when the display section 2 is within a predetermined angular range with respect to the apparatus body section 3.

Where the angle of the display section 2 with respect to the apparatus body section 3 is α, for example, 30 degrees, the center of the gravity of the information processing apparatus 1 is positioned at a front end portion P of the support pads 24 of the battery 22 as seen in FIG. 3. On the other hand, where the angle of the display section 2 with respect to the apparatus body section 3 is β, for example, 60 degrees, the center of gravity is positioned at a boundary location Q between the inclined portion inclined portion 22a and the lower wall portion 22b of the battery 22 as seen in FIG. 3. Accordingly, where the angle of the display section 2 with respect to the apparatus body section 3 is within the range from 30 degrees to 60 degrees, the center of gravity is positioned between the point P and the point Q

Since the center of gravity of the information processing apparatus 1 is positioned at a lower end of the battery 22 where the display section 2 is within the predetermined angular range with respect to the apparatus body section 3 in this manner, irrespective of whether the information processing apparatus 1 is used as an apparatus of the installed type or of the portable type, a stabilized use condition can be secured.

Operations of associated elements upon attachment and detachment of the battery 23 to and from the apparatus body section 3 are similar to those in the case of the battery 22 described above except that the arresting projections 29 of the battery 23 are arrested by the arresting recesses 17a and 17c of the apparatus body section 3 and that the locking projection 37 of the locking lever 33 disposed in the battery 23 is fitted with the locking hole 20 on the front side of the apparatus body section 3. Therefore, description of the operations is omitted herein to avoid redundancy.

Since the battery 23 has a greater charge capacity than the battery 22, it is suitably used when the information processing apparatus 1 is used for a long period of time. Further, when the information processing apparatus 1 is used as an apparatus of the installed type while the battery 23 is attached thereto, the support pads 28 contact with the desk 300 or the like.

On the other hand, when the information processing apparatus 1 is used with the battery 22 attached to the apparatus body section 3, since the total weight of the information processing apparatus 1 and the battery 22 is lower, the information processing apparatus 1 is used suitably as a portable apparatus.

It is to be noted that, while the foregoing description relates to use of the information processing apparatus 1 with the battery 22 or the battery 23 attached to the apparatus body section 3, it is otherwise possible to use a commercial power supply instead of the battery 22 or 23 to use the information processing apparatus 1.

As described above, in the information processing apparatus 1, the arresting projections 25 or the arresting projections 29 and the arresting portions 18 are formed and the locking mechanism 32 is provided in the battery 22 or the battery 23 such that the battery 22 or the battery 23 is attached in a locked state to the apparatus body section 3.

Accordingly, operation for attaching the battery 22 or the battery 23 to the apparatus body section 3 becomes easy. Further, since no locking mechanism is provided on the apparatus body section 3, miniaturization of the apparatus body section 3 can be anticipated.

Further, since the locking mechanism 32 is formed from the locking lever 33, biasing spring 34 and support shaft 35 and hence is simple in configuration, the number of parts is small as much and the space for disposing the locking mechanism 32 may be small. Thus, also miniaturization of the entire information processing apparatus 1 to which the battery 22 or the battery 23 is attached can be anticipated.

While a preferred embodiment of the present invention has been described using specific terms, such description is for illustrative purpose only, and it is to be understood that changes and variations may be made without departing from the spirit or scope of the following claims.

What is claimed is:

1. An information processing apparatus, comprising:
a display section having a display screen on which an indication mark can be moved in response to a predetermined operation;
an apparatus body section having a keyboard;
said display section being supported on said apparatus body section for pivotal motion by and around a pivot shaft in directions in which said display section opens and closes the keyboard;
an indication mark moving operation member disposed at an end portion of said apparatus body section in an axial direction of the pivot shaft, and at an end portion of said apparatus body section adjacent the pivot shaft, and operable for moving the indication mark; and
a control operation member disposed at the other end portion of said apparatus body in the axial direction of the pivot shaft, and at the end portion of said apparatus body section adjacent the pivot shaft for controlling an object indicated by the indication mark moved on said display screen.

2. An information processing apparatus according to claim 1, wherein said control operation member includes a first operation member and a second operation member.

3. An information processing apparatus according to claim 1, further comprising a turning and pressing operation member disposed in the proximity of said indication mark moving operation member or said control operation member for moving the indication mark when said turning and pressing operation member is operated to turn and executing the object indicated by the indication mark when said turning and pressing operation member is operated to push.

4. An information processing apparatus according to claim 1, wherein said indication mark moving operation member has a concave portion for operation formed thereon.

5. An information processing apparatus according to claim 1, wherein said control operation member includes a first operation member and a second operation member and said indication mark moving operation member has a concave portion for operation formed thereon.
